(19) United States
(12) Patent Application Publication
(10) Pub. No.: US 2026/0321522 A1
(43) Pub. Date: Oct. 15, 2026

(54) POWER TRANSMISSION APPARATUS FOR CIRCUIT BREAKER

(71) Applicant: HD HYUNDAI ELECTRIC CO., LTD., Seongnam (KR)

(72) Inventors: Johan Costyson, Zurich (CH); Timothy Sutherland, Zurich (CH)

(21) Appl. No.: 19/538,242

(22) Filed: Feb. 12, 2026

(30) Foreign Application Priority Data
Apr. 15, 2025 (KR) 10-2025-0048656

(51) Int. Cl. H01H 3/32; H01H 9/02

(52) U.S. Cl. CPC H01H 3/32; H01H 9/02

(57) ABSTRACT

A power transmission apparatus includes a support body supporting a contact pin to be slidable, a first guide and a second guide installed on the support body so as to extend parallel to the contact pin, a first slider slidably installed on the first guide and to which driving force is applied, a second slider slidably installed on the second guide and fixed to the contact pin, and a link mechanism connecting the first slider and the second slider.

### CROSS-REFERENCE TO RELATED APPLICATION(S)

This application claims benefit of priority to Korean Patent Application No. 10-2025-0048656 filed on Apr. 15, 2025 in the Korean Intellectual Property Office, the disclosure of which is incorporated herein by reference in its entirety.

### TECHNICAL FIELD

The present disclosure relates to a power transmission apparatus for a circuit breaker for guiding and transmitting force to a contact pin, for example, in a dual-motion high-voltage circuit breaker.

### BACKGROUND

A dual-motion circuit breaker is configured such that a driven-side arc contact of a fixed part moves in a direction opposite to a moving direction of a moving portion in conjunction with the operation of the moving portion to increase a separation gap between a driving-side arc contact and the driven-side arc contact, thereby improving arc extinguishing performance and interruption performance.

Among dual motion circuit breakers is a circuit breaker implementing dual motion using a power transmission apparatus including a link and a lever. In such a power transmission apparatus, linear motion is converted into rotational motion, and then the rotational motion is converted back into linear motion.

Due to the motion conversion, the power transmission apparatus applies force to the driven-side arc contact, and the applied force may lead to undesirable deflection and misalignment of the driven-side arc contact during operation.

### SUMMARY

An aspect of the present disclosure is to provide a power transmission apparatus for a circuit breaker capable of reducing deflection, bending, and friction of a contact pin.

According to an aspect of the present disclosure, a power transmission apparatus includes: a support body supporting a contact pin to be slidable; a first guide and a second guide installed on the support body so as to extend parallel to the contact pin; a first slider slidably installed on the first guide and to which driving force is applied; a second slider slidably installed on the second guide and fixed to the contact pin; and a link mechanism connecting the first slider and the second slider.

The support body may include a plurality of support portions arranged in a longitudinal direction of the contact pin, and the plurality of support portions may include a first support portion and a second support portion arranged at both ends of the support body, and a third support portion disposed between the first support portion and the second support portion.

The first support portion may have a first through-hole, the third support portion may have a second through-hole, and the contact pin may be supported to be slidable through the first through-hole and the second through-hole.

Linear bearings may be mounted on inner surfaces of each of the first through-hole and the second through-hole, respectively.

The first guide may extend to connect the first support portion to the second support portion, and the second guide may extend to connect the first support portion to the third support portion.

The first slider may include a first guide hole through which the first guide is inserted and penetrate, and the second slider may include a second guide hole through which the second guide is inserted and penetrate, and a fixing hole formed parallel to the second guide hole and into which the contact pin is inserted, penetrates through, and fixed.

Linear bearings may be mounted on inner surfaces of the first guide hole and the second guide hole, respectively.

The first slider may receive driving force as one end of a driving rod is connected to the first slider in a portion outside the first guide hole.

The second slider may support a load of the contact pin and transmit the load of the contact pin to the second guide.

The link mechanism may include: a first link member rotatably hinged to the first slider; a second link member rotatably hinged to the second slider; and a third link member having a middle portion rotatably connected to the support body by a pivot pin, one end rotatably connected to the first link member, and the other end rotatably connected to the second link member.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a cross-sectional view illustrating a power transmission apparatus according to an embodiment of the present disclosure; and

FIG. 2 is a cross-sectional view illustrating the operation of the power transmission apparatus according to an embodiment of the present disclosure.

### DETAILED DESCRIPTION

In a dual-motion circuit breaker, a power transmission apparatus, commonly referred to as a “gear,” is used to convert linear motion, input to a fixed part from a moving part of the circuit breaker, into rotational motion, and then convert the rotational motion back into linear motion in opposite directions to open and close a driving-side arc contact and a driven-side arc contact.

While gears are provided with various structures, most gears may be classified into two types of linear and non-linear gears. Linear means that an input stroke and an output stroke are equal, while non-linear means that the input stroke and the output stroke are not equal.

Such gears are designed and configured to increase a relative speed and distance between the arc contacts and to control the movement of the arc contacts in a precise and coordinated manner.

As mentioned above, the gear may implement dual motion by using a link and a lever to convert motion. In the gear, force applied by the link and lever to the driven-side arc contact is not parallel to a motion vector of the driven-side arc contact due to the motion conversion, resulting in undesirable effects.

For example, the driven-side arc contact may experience deflection, and may be bent or deformed due to the applied force. Deflection increases friction between the driven-side arc contact and other components involved in connection and guiding of the driven-side arc contact, thereby increasing stress and mechanical wear, which negatively impacts the overall efficiency and lifespan of the gear.

Furthermore, deflection and bending may cause misalignment between the driving-side arc contact and driven-side arc contact, potentially leading to the driven-side arc contact contacting an insulation nozzle, the driven-side arc contact being asymmetrically eroded due to wear, or even mechanical failure of the driving-side arc contact due to high impact force. Such phenomena may degrade the efficiency of the interruption performance of the circuit breaker and adversely affect the durability and reliability of the circuit breaker.

Therefore, the present disclosure proposes a power transmission apparatus for a circuit breaker capable of effectively reducing deflection, bending, and friction of the driven-side arc contact.

Here, the present disclosure may be applied to gas-insulated circuit breakers, dead tank breakers (DTBs), and live tank breakers (LTBs), but the application of the present disclosure is not necessarily limited thereto.

Hereinafter, the present disclosure is described in detail through drawings. When adding reference numerals to components in each drawing, it should be noted that identical components are denoted with the same reference numerals as much as possible although they are illustrated in different drawings. In addition, when describing the present disclosure, if it is determined that a detailed description of a related known configuration or function may obscure the gist of the present disclosure, the detailed description is omitted.

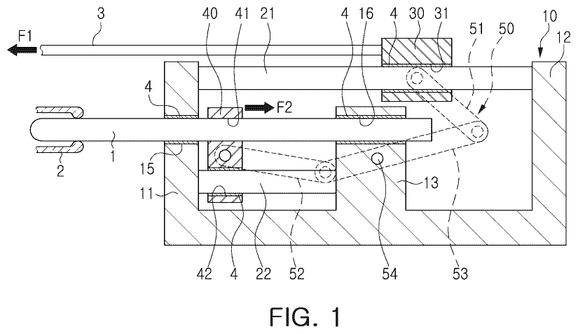

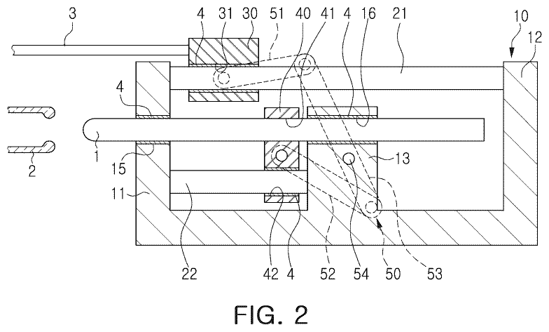

FIG. 1 is a cross-sectional view illustrating a power transmission apparatus according to an embodiment of the present disclosure, and FIG. 2 is a cross-sectional view illustrating the operation of the power transmission apparatus according to an embodiment of the present disclosure.

The power transmission apparatus according to an embodiment of the present disclosure may include a support body 10; a first guide 21; a second guide 22; a first slider 30; a second slider 40; and a link mechanism 50.

The support body 10 may support a contact pin 1 so that the contact pin may slide. Here, the contact pin may function as a driven-side arc contact of a fixed part, for example, in a dual-motion circuit breaker.

The contact pin 1 is a columnar conductor with a hemispherical tip and may be supported by the support body 10 disposed within an internal space of the fixed part (not illustrated). As described above, the contact pin, which is the driven-side arc contact, is configured such that one end thereof may be connected to or disconnected from the driving-side arc contact 2 provided in a moving part (not illustrated). The contact pin may form a conductive path for an arc generated between poles when the circuit breaker is closed or opened.

Specifically, the contact pin 1 may move in a direction opposite to a moving direction of the moving part in conjunction with an advancing or retreating operation of the moving part, so as to be connected to or separated from the driving-side arc contact 2. Accordingly, the contact pin may operate in a dual motion linked to the operation of the moving part.

In other words, in a power transmission apparatus according to an embodiment of the present disclosure, a driving rod 3 may be connected to the moving part for dual motion, and driving force applied by the driving rod may be transmitted to the contact pin 1 to move the contact pin 1.

The support body 10 may be formed in a roughly bracket shape and may include a plurality of support portions arranged in a longitudinal direction of the contact pin. The plurality of support portions may include a first support portion 11 and a second support portion 12 disposed at opposite longitudinal ends of the support body, and a third support portion 13 disposed between the first and second support portions. Here, the longitudinal direction of the support body is parallel to the longitudinal direction of the contact pin.

The first support portion 11 may have a first through-hole 15, and the third support portion 13 may have a second through-hole 16. The first and second through-holes may be disposed at the same height relative to the bottom of the support body and may have the same cross-sectional shape and area. Therefore, the first and second through-holes may be aligned with each other with the same shape and size.

Thus, the contact pin 1 may be slidably supported on the support body 10 by passing through the first through-hole 15 of the first support portion 11 and the second through-hole 16 of the third support portion 13.

Optionally, linear bearings 4 are mounted on the inner surfaces of each of the first through-hole 15 and the second through-hole 16 to facilitate smooth sliding of the contact pin 1. The contact pin may be slidably supported by the linear bearings while minimizing friction.

The first guide 21 and the second guide 22 may be installed on the support body 10 so as to extend parallel to the contact pin 1.

The first guide 21 may extend to connect the first support portion 11 and the second support portion 12, which are disposed at opposite longitudinal ends of the support body 10. One end portion of the first guide may be firmly connected to the inner surface of the first support portion, and the other end portion of the first guide may be firmly connected to the inner surface of the second support portion.

The second guide 22 may extend to connect the first support portion 11, which is disposed at one longitudinal end of the support body 10, and the third support portion 13, which is disposed at the longitudinal midpoint of the support body. One end portion of the second guide may be fixedly connected to the inner surface of the first support portion, and the other portion end portion of the second guide may be fixedly connected to a side surface of the third support portion relatively close to the first support portion.

The first guide 21 may guide linear and reciprocating movement of the first slider 30, and the second guide 22 may guide linear and reciprocating movement of the second slider 40.

The first slider 30 may be slidably installed on the first guide 21 and driving force may be applied thereto. The first slider may be formed in a roughly block shape and may include a first guide hole 31 penetrating through the first slider.

The first guide 21 may be inserted and penetrate through the first guide hole 31 of the first slider 30, allowing the first slider 30 to move linearly and reciprocally relative to the first guide 21.

Optionally, a linear bearing 4 may be mounted on the inner surface of the first guide hole 31 to facilitate smooth sliding relative to the first guide 21, and the linear bearing may allow the first slider 30 to slide on the first guide by minimizing friction.

One end of the driving rod 3 may be connected to a portion of the first slider 30 outside the first guide hole 31. The driving rod, with the other end connected to the moving part, may apply driving force transmitted from the moving part to the first slider, thereby moving the first slider.

The second slider 40 may be slidably installed on the second guide 22 and may be secured to the contact pin 1. The second slider may be formed in a roughly block shape and may include a second guide hole 42 penetrating through the second slider and a fixing hole 41 formed and disposed parallel to the second guide hole.

The second guide 22 may be inserted and penetrate through the second guide hole 42 of the second slider 40, allowing the second slider to move linearly and reciprocally relative to the second guide.

Optionally, a linear bearing 4 is mounted on the inner surface of the second guide hole 42 to ensure smooth sliding relative to the second guide 22, and the linear bearing may allow the second slider 40 to slide on the second guide by minimizing friction.

In addition, the contact pin 1 may be inserted, penetrate through, and fixed into the fixing hole 41 of the second slider 40, allowing the second slider and the contact pin to move linearly and reciprocally along the second guide 22. The contact pin may be fixedly coupled to the fixing hole of the second slider by, for example, press-fitting, such as interference fit, adhesive bonding, welding, or screw-joining.

By fixedly connecting the second slider 40 and the contact pin 1 together, the second slider and the contact pin may slide together and simultaneously and may be restricted to a single degree of freedom.

The link mechanism 50 may connect the first slider 30 and the second slider 40. The link mechanism may be configured as a multi-bar link mechanism with a plurality of link members.

For example, the link mechanism 50 may include a first link member 51 rotatably hinged to the first slider 30, a second link member 52 rotatably hinged to the second slider 40, and a third link member 53 having middle portion rotatably connected to the third support portion 13 of the support body 10 via a pivot pin 54 and having both ends rotatably connected to the first and second link members, respectively.

Since the link mechanism is disposed between and connect the first slider 30 and the second slider 40, driving force applied to the first slider via the driving rod 3 may be transmitted to the second slider, and accordingly, the contact pin 1 may simultaneously move linearly and reciprocally with the second slider.

Hereinafter, the operation of the power transmission apparatus according to an embodiment of the present disclosure is described. For example, although a case in which the moving part and the fixed part of a circuit breaker are separated from each other is mainly described, the description may also include cases in which the moving part and the fixed part are connected to each other, if necessary.

FIG. 1 illustrates a position of the contact pin 1 acting as the driven-side arc contact. From this position, when the moving part is moved to be separated from the fixed part, the driving rod 3 connected to the moving part may move in the same direction as that of the moving part.

Driving force F1 applied by the driving rod 3 to pull toward the moving part may be applied to the first slider 30 movable linearly along the first guide 21.

By the driving force F1, the first slider 30 may slide along the first guide 21 toward the first support portion 11 of the support body 10, and the first link member 51 of the link mechanism 50 connected to the first slider may move and rotate together.

As the first link member 51 moves and rotates, the third link member 53 of the link mechanism 50 may rotate around the pivot pin 54, and due to the rotation of the third link member, the second link member 52 may move and rotate together.

As the second link member 52 moves and rotates, pulling force F2 may be applied to the second slider 40 movable linearly along the second guide 22.

By the force F2, the second slider 40 connected to the second link member 52 may slide along the second guide 22 toward the third support portion 13 of the support body 10.

Accordingly, the contact pin 1 fixed to the second slider 40 may slide on the support body 10 in a direction in which the contact pin 1 is separated from the driving-side arc contact 2.

In this case, the second slider 40 not only supports a load of the contact pin 1 but also transfers the load of the contact pin to the second guide 22, thereby minimizing bending stress acting on the contact pin.

Accordingly, friction of the contact pin 1 may be minimized to allow for smooth sliding movement, and bending stress may also be minimized such that deflection or deformation may be substantially eliminated.

Once the separation between the moving part and the fixed part of the circuit breaker is completed, the contact pin 1 may remain separated from the driving-side arc contact 2, as illustrated in FIG. 2.

Meanwhile, when the moving part and the fixed part are connected to each other, the operation of the components may proceed in the reverse order and direction of the aforementioned process from the state illustrated in FIG. 2.

As described above, according to the embodiments of the present disclosure, the contact pin may be accurately guided and the risk of impact on the contact pin due to misalignment may be minimized, thereby improving the efficiency of power transmission and interrupting performance, as well as the durability and reliability of the circuit breaker.

The above description is merely illustrative of the technical idea of the present disclosure, and various modifications and changes may be made by those skilled in the art without departing from the essential characteristics of the present disclosure.

Accordingly, the embodiments disclosed in the present disclosure and the accompanying drawings are not intended to limit the technical idea of the present disclosure but to describe the present disclosure, and the scope of the technical idea of the present disclosure is not limited by the embodiments and the accompanying drawings. The protection scope of the present disclosure should be interpreted by the following claims, and all technical ideas within the equivalent scope should be interpreted as being included in the scope of the present disclosure.

What is claimed is:

1. A power transmission apparatus comprising:
a support body supporting a contact pin to be slidable;
a first guide and a second guide installed on the support body so as to extend parallel to the contact pin;
a first slider slidably installed on the first guide and to which driving force is applied;
a second slider slidably installed on the second guide and fixed to the contact pin; and
a link mechanism connecting the first slider and the second slider.

2. The power transmission apparatus of claim 1, wherein
the support body includes a plurality of support portions arranged in a longitudinal direction of the contact pin, and
the plurality of support portions include a first support portion and a second support portion arranged at both ends of the support body, and a third support portion disposed between the first support portion and the second support portion.

3. The power transmission apparatus of claim 2, wherein
the first support portion has a first through-hole,
the third support portion has a second through-hole, and
the contact pin is supported to be slidable through the first through-hole and the second through-hole.

4. The power transmission apparatus of claim 3, wherein linear bearings are mounted on inner surfaces of each of the first through-hole and the second through-hole, respectively.

5. The power transmission apparatus of claim 2, wherein
the first guide extends to connect the first support portion to the second support portion, and
the second guide extends to connect the first support portion to the third support portion.

6. The power transmission apparatus of claim 1, wherein
the first slider includes a first guide hole through which the first guide is inserted and penetrate, and
the second slider includes a second guide hole through which the second guide is inserted and penetrate, and a fixing hole formed parallel to the second guide hole and into which the contact pin is inserted, penetrates through, and fixed.

7. The power transmission apparatus of claim 6, wherein linear bearings are mounted on inner surfaces of the first guide hole and the second guide hole, respectively.

8. The power transmission apparatus of claim 6, wherein the first slider receives driving force as one end of a driving rod is connected to the first slider in a portion outside the first guide hole.

9. The power transmission apparatus of claim 6, wherein the second slider supports a load of the contact pin and transmits the load of the contact pin to the second guide.

10. The power transmission apparatus of claim 1, wherein
the link mechanism includes:
a first link member rotatably hinged to the first slider;
a second link member rotatably hinged to the second slider; and
a third link member having a middle portion rotatably connected to the support body by a pivot pin, one end rotatably connected to the first link member, and the other end rotatably connected to the second link member.
